(19) United States
(12) Patent Application Publication
(10) Pub. No.: US 2026/0259424 A1
(43) Pub. Date: Sep. 3, 2026

(54) CAMERA MODULE

(71) Applicant: SAMSUNG ELECTRO-MECHANICS CO., LTD., Suwon-si (KR)

(72) Inventors: Sang Hun HAN, Suwon-si (KR); Min Gyu KIM, Suwon-si (KR); Jae Ho BAIK, Suwon-si (KR); Jeong A KIM, Suwon-si (KR)

(73) Assignee: SAMSUNG ELECTRO-MECHANICS CO., LTD., Suwon-si (KR)

(21) Appl. No.: 19/430,574

(22) Filed: Dec. 23, 2025

(30) Foreign Application Priority Data
Feb. 28, 2025 (KR) 10-2025-0026412
Jul. 18, 2025 (KR) 10-2025-0097633

(51) Int. Cl. G02B 27/64; G03B 5/00

(52) U.S. Cl. CPC G02B 27/646; G03B 5/00; G03B 2205/0007; G03B 2205/0069

(57) ABSTRACT

A camera module includes a housing; a carrier, disposed in the housing, movable in an optical axis direction with respect to the housing, and including a protrusion; a holder, disposed on the carrier, movable in a direction perpendicular to an optical axis with respect to the carrier, the holder being configured to support a lens module; a first magnet disposed on one side surface of the holder; and a first yoke disposed in the protrusion to oppose the first magnet in the optical axis direction, wherein the protrusion protrudes from a lower surface of the carrier toward a bottom surface of the housing.

### CROSS-REFERENCE TO RELATED APPLICATIONS

This application claims the benefit under 35 USC 119(a) of Korean Patent Application Nos. 10-2025-0026412 filed on February 28, 2025, and 10-2025-0097633 filed on July 18, 2025, in the Korean Intellectual Property Office, the entire disclosures of which are incorporated herein by reference for all purposes.

### BACKGROUND

### 1. Field

The present disclosure relates to a camera module.

### 2. Description of the Background

Camera modules are used in portable electronic devices such as smartphones, tablet PCs, and notebook computers.

Most of the camera modules adopted in portable electronic devices may have an autofocus (AF) function and an optical image stabilization (OIS) function.

For miniaturization of the camera module, an actuator for AF and/or OIS driving may need to be disposed within a limited space. To this end, a structure in which a lens holder is directly disposed on a carrier without a ball guide may be considered.

However, in such a structure, a distance between an OIS driving magnet mounted on a lens holder and a yoke on a bottom surface of the carrier may be narrow, such that a magnetic attractive force may increase, making accurate control for OIS driving difficult.

Accordingly, there is a need for a camera module having a structure in which a sufficient distance between the OIS driving magnet and the yoke is maintained while having a simple internal component without a ball guide.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a housing; a carrier, disposed in the housing, movable in an optical axis direction with respect to the housing, and including a protrusion; a holder, disposed on the carrier, movable in a direction perpendicular to an optical axis with respect to the carrier, the holder being configured to support a lens module; a first magnet disposed on one side surface of the holder; and a first yoke disposed in the protrusion to oppose the first magnet in the optical axis direction, wherein the protrusion protrudes from a lower surface of the carrier toward a bottom surface of the housing.

In the optical axis direction, a distance between the first magnet and the first yoke may be greater than or equal to a distance between the first magnet and a lower surface of the carrier.

A region of the bottom surface of the housing, opposing the protrusion, may have an accommodation groove.

The protrusion may be exposed in the optical axis direction through the accommodation groove.

At least a portion of the protrusion may be accommodated in the accommodation groove.

The camera module may further include a first driving portion configured to provide a driving force to the holder. The first driving portion may include the first magnet and a first coil disposed to oppose the first magnet in the direction perpendicular to the optical axis.

The holder may be supported by the carrier in the optical axis direction.

The camera module may further include a first ball member disposed between the carrier and the holder.

The first ball member may be in contact with each of the carrier and the holder at one point in the optical axis direction.

The camera module may further include a second driving portion configured to provide a driving force to the carrier. The second driving portion may include a second magnet disposed on a side surface of the carrier, and a second coil disposed to oppose the second magnet in the direction perpendicular to the optical axis.

The carrier may be supported by the housing in the direction perpendicular to the optical axis.

The camera module may further include a second ball member disposed between the housing and the carrier.

In another general respect, a camera module includes a housing; a carrier, disposed in the housing, movable in an optical axis direction with respect to the housing; a holder, disposed on the carrier, movable in at least two axial directions, perpendicular to an optical axis, with respect to the carrier; a first-first magnet disposed on one side surface of the holder; and a first-first yoke, disposed on a lower surface of the carrier, configured to apply magnetic attractive force to the first-first magnet in the optical axis direction. A distance between a bottom surface of the housing and the first-first yoke is less than a distance between the bottom surface of the housing and the lower surface of the carrier.

The camera module may further include a first-second magnet disposed on another side surface of the holder extending from the one side surface; and a first-second yoke, disposed on the lower surface of the carrier, configured to apply magnetic attractive force to the first-second magnet in the optical axis direction.

The first-first magnet may include regions having different polarities in a direction perpendicular to the optical axis.

The first-first yoke may include a plurality of first yokes, and each of the plurality of first yokes is disposed to oppose, in the optical axis direction, a respective polarity region within the first-first magnet.

Other features and aspects will be apparent from the following detailed description, the drawings, and the claims.

### BRIEF DESCRIPTION OF DRAWINGS

FIG. 1 is a perspective view of a camera module according to an example embodiment of the present disclosure.

FIG. 2 is an exploded perspective view of a camera module according to an example embodiment of the present disclosure.

FIG. 3 is a diagram of a coupling relationship between a housing, a carrier, and a holder.

FIG. 4 is a side view of a carrier and a holder as viewed in direction “A” of FIG. 1.

FIG. 5 is a cross-sectional view taken along line I–I’ of FIG. 1.

FIG. 6 is an enlarged view of region “C” of FIG. 5.

FIG. 7 is a cross-sectional view taken along line II–II’ of FIG. 1.

FIG. 8 is a side view of a carrier as viewed in direction “A” of FIG. 1.

FIG. 9 is a bottom view of a carrier as viewed in direction “B” of FIG. 1.

FIG. 10 is a bottom view of a housing as viewed in direction “B” of FIG. 1.

FIG. 11 is a bottom view of a carrier and a housing as viewed in direction B of FIG. 1.

FIG. 12 is a side view of a camera module according to a comparative example, corresponding to FIG. 4.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being "on," "connected to," or "coupled to" another element, it may be directly "on," "connected to," or "coupled to" the other element, or there may be one or more other elements intervening therebetween. In contrast, when an element is described as being "directly on," "directly connected to," or "directly coupled to" another element, there can be no other elements intervening therebetween.

As used herein, the term "and/or" includes any one and any combination of any two or more of the associated listed items; likewise, "at least one of" includes any one and any combination of any two or more of the associated listed items.

Although terms such as "first," "second," and "third" may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as "above," "upper," "below," "lower," and the like, may be used herein for ease of description to describe one element’s relationship to another element as shown in the figures. Such spatially relative terms are intended to encompass different orientations of the device in use or operation in addition to the orientation depicted in the figures. For example, if the device in the figures is turned over, an element described as being "above," or "upper" relative to another element would then be "below," or "lower" relative to the other element. Thus, the term "above" encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles "a," "an," and "the" are intended to include the plural forms as well, unless the context clearly indicates otherwise. The terms "comprises," "includes," and "has" specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term "may" with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

The camera module 1000, according to an example embodiment of the present disclosure, may be used to capture images and videos of an external subject. The camera module 1000 according to the present example embodiment may be applied to a portable electronic device such as a mobile communication terminal, a smartphone, a tablet PC, or the like.

In the camera module 1000 according to an example embodiment of the present disclosure, a carrier 300 may be disposed in the housing 110, and a holder 330 may be disposed on the carrier 300. A lens module 200 may be mounted on the holder 330.

The camera module 1000 according to an example embodiment of the present disclosure may include a first driving portion 400 moving the holder 330 in a direction (an X-axis direction or a Y-axis direction), perpendicular to an optical axis, to implement an optical imaging stabilization (OIS) function. The camera module 1000 according to an example embodiment of the present disclosure may freely drive the holder 330 on the carrier 300 in a direction, perpendicular to the optical axis, without a ball guide, thereby reducing a thickness of the camera module 1000 in an optical axis direction (Z-axis direction).

In addition, the camera module 1000 according to an example embodiment of the present disclosure may include a second driving portion 500 moving the carrier 300 in the optical axis direction (Z-axis direction) to implement an autofocus (AF) function.

In a structure in which the holder 330 is directly disposed on the carrier 300, a distance between a first magnet 410 and a first yoke 470 may be decreased, resulting in a strong attractive force. Thus, it may be difficult to control OIS driving.

Accordingly, the camera module 1000 according to an example embodiment of the present disclosure may secure a distance between the first magnet 410 mounted on the holder 330 and the first yoke 470 mounted on the carrier 300, thereby preventing an excessive magnetic attractive force from being generated. Accordingly, an effect of a magnetic attractive force between the first magnet 410 and the first yoke 470 on OIS driving may be minimized.

To secure a distance d1 in the optical axis direction (Z-axis direction) between the first magnet 410 and the first yoke 470, the first yoke 470 may be accommodated in the protrusion 310 protruding downwardly from a bottom surface of the carrier 300.

Hereinafter, detailed components of the camera module 1000 according to an example embodiment of the present disclosure will be described in detail with reference to the drawings.

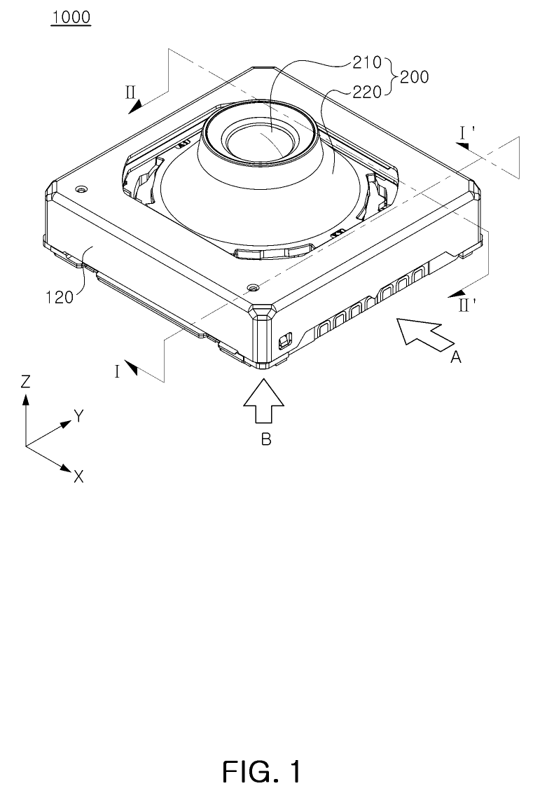

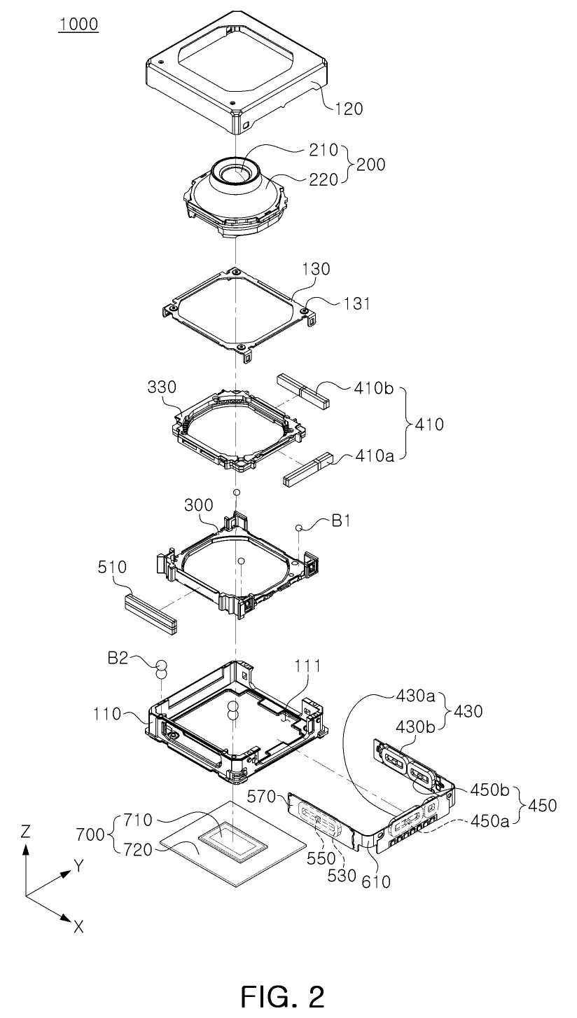

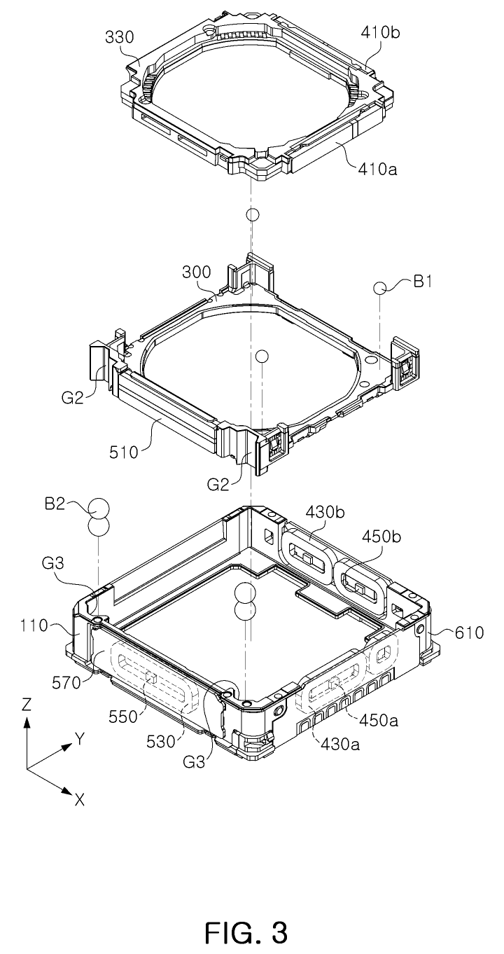

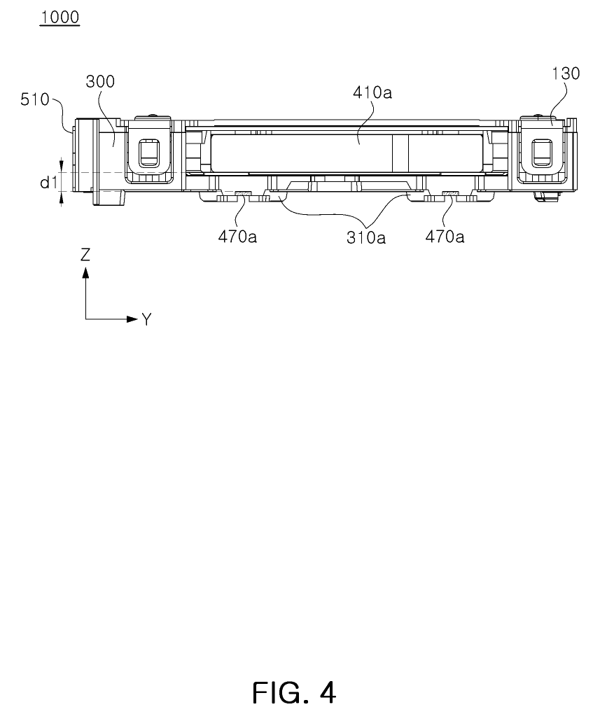

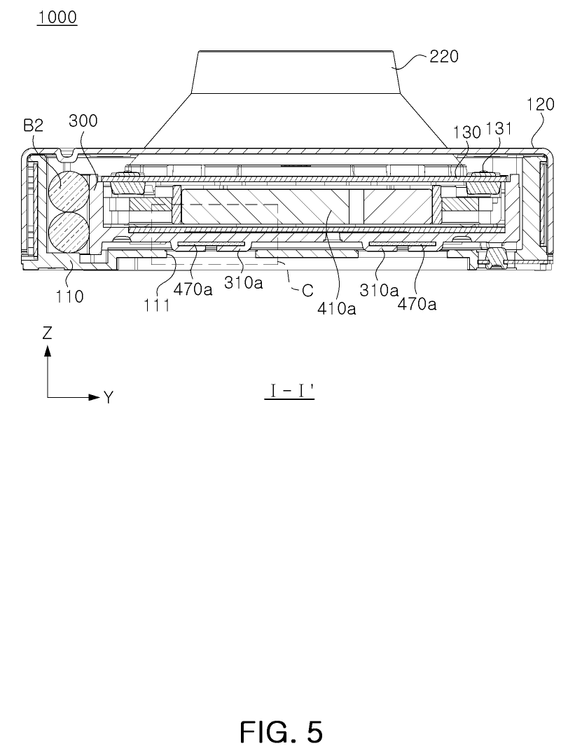

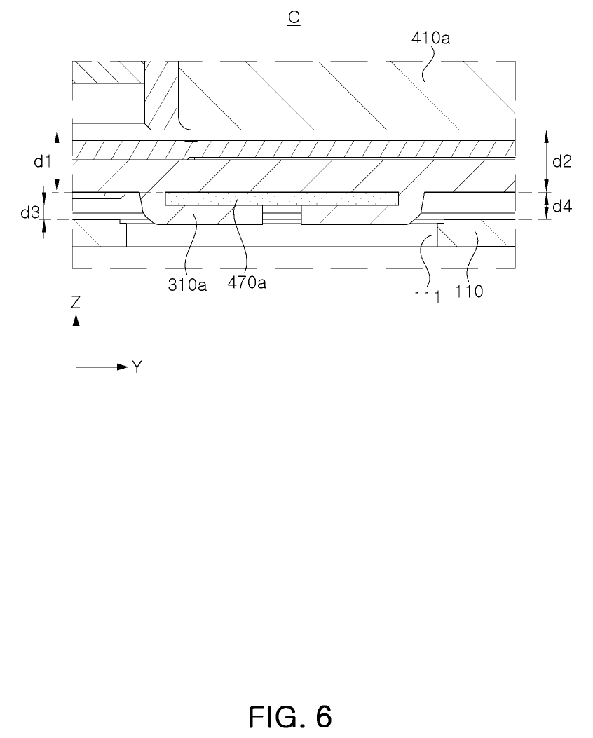

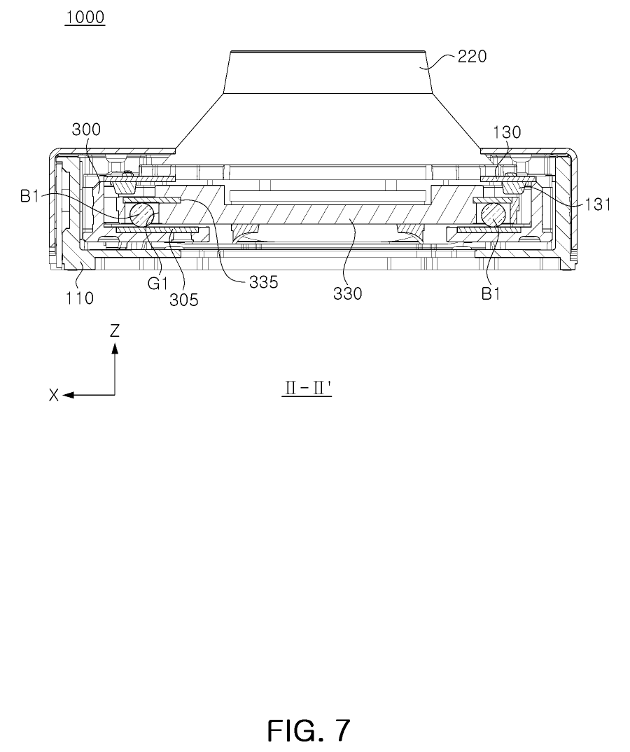

FIG. 1 is a perspective view of a camera module 1000 according to an example embodiment of the present disclosure. FIG. 2 is an exploded perspective view of a camera module 1000 according to an example embodiment of the present disclosure. FIG. 3 is a diagram of a coupling relationship between a housing 110, a carrier 300, and a holder 330. FIG. 4 is a side view of a carrier 300 and a holder 330 as viewed in direction “A” of FIG. 1. FIG. 5 is a cross-sectional view taken along line I–I’ of FIG. 1. FIG. 6 is an enlarged view of region “C” of FIG. 5. FIG. 7 is a cross-sectional view taken along line II–II’ of FIG. 1.

Referring to FIGS. 1 to 3, a camera module 1000 according to an example embodiment of the present disclosure may include a housing 110, a carrier 300 disposed in the housing 110, a holder 330 disposed on the carrier 300, and a lens module 200 mounted on the holder 330. In addition, the camera module 1000 may include a lens driving apparatus moving the lens module 200, an image sensor module 700 converting light incident through the lens module 200 into an electrical signal, and a housing 110 and a case 120 accommodating the lens module 200 and the lens driving apparatus.

The lens module 200 may include at least one lens 210 aligned along an optical axis, and a lens barrel 220 accommodating the lens 210.

The lens barrel 220 may have a hollow cylindrical shape, and a plurality of lenses 210 may be disposed in the lens barrel 220.

A plurality of lenses 210 may be mounted in the lens barrel 220 in an optical axis direction. A plurality of lenses may be disposed in a desired number, and respective lenses may have the same or different optical characteristics.

The lens driving apparatus may move the lens barrel 220.

In an example embodiment, the lens driving apparatus may include a first driving portion 400 and a second driving portion 500. During image capturing, the first driving portion 400 may stabilize an image by moving the lens module 200 in a direction (an X-axis direction or a Y-axis direction), perpendicular to an optical axis. In addition, the second driving portion 500 may perform focus adjustment by moving the lens module 200 in an optical axis direction (Z-axis direction).

In an example embodiment, the carrier 300 may be disposed in the housing 11, and may be movable in the optical axis direction (Z-axis direction) with respect to the housing 110.

In addition, the holder 330 may be disposed on the carrier 300, and may be movable in a direction (including the X-axis direction and the Y-axis direction), perpendicular to the optical axis, with respect to the carrier 300.

Details related to the driving of the carrier 300 and the holder 330 will be described below together with the first driving portion 400 and the second driving portion 500.

The image sensor module 700 may convert light incident through the lens module 200 into an electrical signal.

In an example embodiment, the image sensor module 700 may include an image sensor 710, and a sensor substrate 720 on which the image sensor 710 is mounted.

The image sensor 710 may convert light incident through the lens module 200 into an electrical signal. For example, the image sensor 710 may be a charge-coupled device (CCD) or a component metal-oxide semiconductor (CMOS).

The electrical signal, converted through the image sensor 710, may be output as an image or a video through a display unit of a portable electronic device.

The image sensor 710 may be electrically connected to the sensor substrate 720. For example, the sensor substrate 720 may be a printed circuit board (PCB).

The lens module 200 and the lens driving apparatus may be accommodated in the housing 110. In an example embodiment, the housing 110 may have an internal space, and the lens module 200 and the lens driving apparatus may be accommodated in the internal space of the housing 110.

In addition, the image sensor module 700 may be disposed on a lower portion of the housing 110. In an example embodiment, the sensor substrate 720 may be coupled to a bottom surface of the housing 110, and the image sensor 710 may be exposed to the internal space of the housing 110 in a state in which the sensor substrate 720 is coupled to the housing 110.

A main substrate 610 for providing a driving signal to the first driving portion 400 and the second driving portion 500 may be disposed on a side surface of the housing 110. In an example embodiment, the main substrate 610 may be disposed to surround a side surface of the housing 110.

A driving coil and a position sensor, included in the first driving portion 400 and the second driving portion 500, may be disposed on the main substrate 610.

The side surface of the housing 110 may have an opening, and the driving coil and the position sensor may be disposed in the opening to be exposed to the internal space of the housing 110.

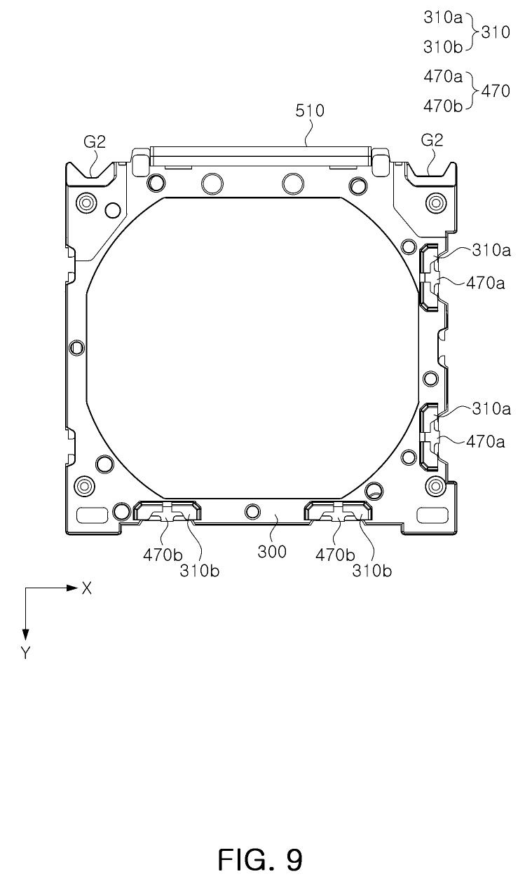

The bottom surface of the housing 110, according to the present example embodiment, may have an accommodation groove 111 to avoid interference with a protrusion 310 of the carrier 300 (see FIGS. 9 to 11). The accommodation groove 111 may be formed in a region of the housing 110 opposing the protrusion 310 in the optical axis direction (Z-axis direction), and the protrusion 310 may be exposed in the optical axis direction (Z-axis direction) through the accommodation groove 111. For example, the protrusion 310 may be exposed toward the image sensor module 700 through the accommodation groove 111. In addition, at least a portion of the protrusion 310 may be accommodated in the accommodation groove 111.

The case 120 may be coupled to cover the internal space of the housing 110 to protect components disposed in the internal space.

In addition, the case 120 may have a function of shielding electromagnetic waves. To this end, the case 120 may be formed of a metallic material, and may be grounded to a ground pad included in the sensor substrate 720.

The camera module 1000, according to an example embodiment of the present disclosure, may further include a stopper 130 for absorbing impacts transmitted to internal components due to external impacts or the like and preventing the holder 330 from being separated from the carrier 300.

The stopper 130 may be coupled to the carrier 300 to cover at least a portion of an upper surface of the holder 330. The stopper 130 may include a main body disposed to cover the upper surface of the holder 330, and a fastening portion extending from each corner portion of the main body in the optical axis direction (Z-axis direction). The stopper 130 may be coupled to the carrier 300 through the fastening portion. In an example embodiment, the fastening portion may be inserted into a groove disposed in the carrier 300 and fixed.

The stopper 130, according to an example embodiment, may include a damper 131 for buffering. The damper 131 may be disposed on the stopper 130 to oppose the case 120 in the optical axis direction (Z-axis direction). The damper 131 may be disposed at each corner portion of the main body of the stopper 130, and may protrude toward an upper portion and a lower side of the stopper 130, thereby mitigating impacts in the optical axis direction (Z-axis direction) between the case 120 and the stopper 130 and between the stopper 130 and the holder 330.

In an example embodiment, the damper 131 may be disposed to penetrate the stopper 130. For example, the damper 131 may be inserted into a hole formed in the main body of the stopper 130 in the optical axis direction (Z-axis direction), but the present disclosure is not limited thereto. The damper 131 may be coupled to the stopper 130 through an insert injection process, and the damper 131 may be bonded to the stopper 130 by an adhesive or the like after the stopper 130 and the damper 131 are separately manufactured.

In an example embodiment, the damper 131 may be formed of a material such as an elastic polymer (for example, polyurethane), rubber, silicone, or the like. A shape of the damper 131, formed of such a material, may be elastically deformed upon coming into contact or colliding with the case 120, thereby effectively reducing impact and noise.

Hereinafter, components for OIS and AF driving will be described with reference to FIGS. 2 to 7.

A plurality of layers of components, moving together with the lens module 200, may be disposed in the internal space of the housing 110. In an example embodiment, the stopper 130, the carrier 300, and the holder 330 may be accommodated in the internal space of the housing 110. The lens module 200 may be coupled to the holder 330.

The stopper 130, the carrier 300, and the holder 330 may be provided in the internal space of the housing 110 to be movable in the optical axis direction (Z-axis direction). That is, the stopper 130, the carrier 300, and the holder 330 may all be moving bodies relative to the housing 110 during AF. In addition, the holder 330 may be provided to be further movable in a direction perpendicular to the optical axis. Such a movement may be a movement relative to the stopper 130 and the carrier 300. That is, during OIS, the holder 330 may be a moving body, while the stopper 130 and the carrier 300 may be a fixed body.

Hereinafter, a component for OIS driving of the camera module 1000 according to an example embodiment of the present disclosure will be described.

The camera module 1000, according to an example embodiment of the present disclosure, may include a first driving portion 400 generating a driving force in a direction perpendicular to the optical axis.

In an example embodiment, the first driving portion 400 may include a first magnet 410 and a first coil 430.

The first magnet 410 may include a region having different polarities in a direction perpendicular to the optical axis. For example, the first magnet 410 may include an N-pole region and an S-pole region in a direction perpendicular to the optical axis, and may include a neutral region between the N-pole region and the S-pole region, but the present disclosure is not limited thereto. The first magnet 410 may be implemented as a combination of unipolar magnets having an N-pole or an S-pole without a neutral region.

The first magnet 410 and the first coil 430 may be provided as a plurality of first magnets 410 and a plurality of first coils 430. For example, the first magnet 410 may include a first-first magnet 410a and a first-second magnet 410b disposed on both side surfaces of the holder 330, respectively. In addition, the first coil 430 may include a first-first coil 430a opposing the first-first magnet 410a, and a first-second coil 430b opposing the first-second magnet 410b.

The first-first magnet 410a and the first-second magnet 410b may be disposed on two side surfaces of the holder 330. For example, the first-first magnet 410a and the first-second magnet 410b may be disposed to be perpendicular to each other. The first-first coil 430a and the first-second coil 430b may be disposed on two side surfaces of the housing 110 opposing the two side surfaces of the holder 330, respectively, and may be disposed perpendicular to each other.

In an example embodiment, the first coil 430 may be disposed on the main substrate 610. The first coil 430 may be disposed to directly oppose the first magnet 410 through a through-hole formed in the housing 110. Specifically, the first-first coil 430a may be disposed to directly oppose the first-first magnet 410a through a through-hole formed in one side surface of the housing 110. In addition, the first-second coil 430b may be disposed to directly oppose the first-second magnet 410b through a through-hole formed in the other side surface of the housing 110. The one side surface and the other side surface of the housing 110 may correspond to two surfaces directly connected to each other.

The first magnet 410 and the first coil 430 may be disposed to oppose each other in a direction perpendicular to the optical axis, to generate a driving force in a direction in which the first magnet 410 and the first coil 430 oppose each other.

According to an example embodiment of the present disclosure, a first ball member B1 guiding a movement during OIS may be configured to roll in multiple directions, such that unintended rotation may occur during an OIS process. Accordingly, the first driving portion 400 may have a component capable of generating a rotational force.

For example, the first-first magnet 410a and/or the first-second magnet 410b may include one or more magnets, and the first-first coil 430a and/or the first-second coil 430b may include a plurality of coils. At least one of the first-first coil 430a and the first-second coil 430b may include a plurality of independently controllable coils, thereby controlling a driving force.

The first driving portion 400 may cancel unintended rotation by controlling a driving force generated by the first-first magnet 410a and the first-first coil 430a and/or a driving force generated by the first-second magnet 410b and the first-second coil 430b. Alternatively, similarly, a deviation may be applied to the driving forces, or a rotational force may be intentionally generated using a resultant force of the driving forces.

A first position sensor 450 may be disposed on the main substrate 610. The first position sensor 450 may include a first-first position sensor 450a and a first-second position sensor 450b. The first-first position sensor 450a may be disposed on a surface of the main substrate 610 the same as a surface of the main substrate 610 on which the first-first coil 430a is disposed, and the first-second position sensor 450b may be disposed on a surface of the main substrate 610 the same as a surface of the main substrate 610 on which the first-second coil 430b is disposed. In an example embodiment, at least one of the first-first position sensor 450a and the first-second position sensor 450b may be provided as a plurality of position sensors to detect rotation of the lens module 200.

The first-first position sensor 450a and the first-second position sensor 450b may be magnetic sensors, for example, Hall sensors, but the present disclosure is not limited thereto. The first-first position sensor 450a and/or the first-second position sensor 450b may be implemented as other types of sensors, such as a gyroscope or an accelerometer.

The first ball member B1 may be disposed between the holder 330 and the carrier 300.

The first ball member B1 may include a plurality of ball members. For example, the first ball member B1 may be provided as three or four first ball members B1, and the first ball members B1 may be spaced apart from each other to be respectively positioned at corner portions of the holder 330 and the carrier 300.

The first ball member B1 may guide the movement of the holder 330, and may maintain a distance between the holder 330 and the carrier 300.

Referring to FIG. 7, a surface of the holder 330, opposing the carrier 300 in the optical axis direction (Z-axis direction), may have a first guide groove G1 in which the first ball member B1 is accommodated. The first ball member B1 may be disposed between the first guide groove G1 and a bottom surface of the carrier 300. The number of first guide grooves G1 may be provided to correspond to the number of first ball members B1.

The first guide groove G1 may have a polygonal or circular shape when viewed in the optical axis direction (Z-axis direction). In addition, a cross-sectional area of the first guide groove G1 may be greater than a cross-sectional area of the first ball member B1. For example, on a cross-section (X-Y cross-section) perpendicular to the optical axis, a cross-sectional area of the first guide groove G1 may be greater than a cross-sectional area of the first ball member B1. For example, when the first guide groove G1 has a circular cross-section, a diameter of the first guide groove G1 may be greater than a diameter of the first ball member B1.

The first ball member B1 may be disposed between the first guide groove G1 and the bottom surface of the carrier 300 to perform rolling motion in a direction of a driving force generated by the first driving portion 400. The first ball member B1 may perform a rolling motion in a direction perpendicular to the optical axis, and may freely perform a rolling motion on a plane perpendicular to the optical axis.

Referring to FIG. 7, in the present example embodiment, the first ball member B1 may be in contact with each of the carrier 300 and the holder 330 at one point in the optical axis direction (Z-axis direction). By such a one-point contact structure, the holder 300 may be freely guided in multiple directions, perpendicular to the optical axis.

At least a portion of a surface on which the carrier 300 and the holder 330 oppose each other may have the first guide groove G1. In the present example embodiment, the first guide groove G1 may be disposed in the holder 330, but the present disclosure is not limited thereto. The first guide groove G1 may be disposed in the carrier 300 or may be disposed in both the holder 330 and the carrier 300.

The first guide groove G1 may have a bottom surface, and the bottom surface of the first guide groove G1 may be disposed to be parallel to the bottom surface of the carrier 300. In addition, each of the bottom surfaces of the first guide groove G1 and the carrier 300 may be disposed to be perpendicular to the optical axis. In addition, the first guide groove G1 may include a sidewall extending from an edge of the bottom surface in the optical axis direction.

The first ball member B1 may be in contact with each of the bottom surfaces of the first guide groove G1 and the carrier 300. Specifically, the first ball member B1 may be in contact with the bottom surface of the first guide groove G1 at one point, and may be in contact with the bottom surface of the carrier 300 at one point. In addition, the first ball member B1 may be spaced apart from or in contact with a sidewall of the first guide groove G1 depending on a position changed while performing rolling motion.

In an example embodiment, the carrier 300 and the holder 330 may include reinforcing plates 305 and 335. For example, the carrier 300 may include a first reinforcing plate 305, and the holder 330 may include a second reinforcing plate 335. The first reinforcing plate 305 and the second reinforcing plate 335 may be disposed to oppose each other in the optical axis direction (Z-axis direction).

The reinforcing plates 305 and 335 may be configured to supplement the rigidity of the carrier 300 and the holder 330, and may be formed of a material having rigidity higher than that of a main material of the carrier 300 and the holder 330. For example, the reinforcing plates 305 and 335 may be formed of stainless steel.

The reinforcing plates 305 and 335 may be integrally manufactured with the carrier 300 and the holder 330 by insert injection to form a portion of the carrier 300 and the holder 330.

The reinforcing plates 305 and 335 may be disposed to be partially exposed from the carrier 300 and the holder 330. For example, the reinforcing plates 305 and 335 may be disposed to be exposed to the bottom surface of the first guide groove G1, in which the first ball member B1 is accommodated, and to the bottom surface of the carrier 300. Accordingly, the first ball member B1 may roll in a state of being in contact with the reinforcing plates 305 and 335.

The holder 330 may be supported by the carrier 300 with the first ball member B1 interposed therebetween. In an example embodiment, a first yoke 470 may be disposed in the carrier 300 to oppose the first magnet 410 with the first ball member B1 interposed therebetween.

Specifically, the first yoke 470 according to the present example embodiment may include a first-first yoke 470a disposed to oppose the first-first magnet 410a in the optical axis direction (Z-axis direction), and a first-second yoke 470b disposed to oppose the first-second magnet 410b in the optical axis direction (Z-axis direction).

The first yoke 470 may correspond to a magnetic body, and may concentrate magnetic force generated in the first magnet 410 by forming a magnetic circuit with the first magnet 410.

The camera module 1000, according to an example embodiment of the present disclosure, may be freely driven in a direction (including the X-axis direction and the Y-axis direction), perpendicular to the optical axis, by the holder 330 directly disposed on the carrier 300. In this case, a thickness of the camera module 1000 may be reduced, but a distance between the first magnet 410 for OIS driving and the first yoke 470 corresponding thereto may be reduced, and thus a strong magnetic attractive force may act therebetween. Accordingly, OIS driving may be affected, thereby making precise driving difficult.

The camera module 1000, according to an example embodiment of the present disclosure, may include components for securing a distance between the first magnet 410 and the first yoke 470, and the above-described components will be described in detail below with reference to the drawings.

FIG. 4 is a side view of a carrier 300 and a holder 330 as viewed in direction “A” of FIG. 1. FIG. 5 is a cross-sectional view taken along line I–I’ of FIG. 1. FIG. 6 is an enlarged view of region “C” of FIG. 5.

Referring to FIGS. 4 to 6, in the present example embodiment, the carrier 300 may include a protrusion 310.

The protrusion 310 may be disposed in a region of the carrier 300 overlapping the first magnet 410 in the optical axis direction (Z-axis direction), and the first yoke 470 may be accommodated therein.

In addition, the protrusion 310 may be disposed to protrude from a lower surface of the carrier 300 toward the bottom surface of the housing 110. That is, the protrusion 310 may correspond to a component protruding from the lower surface of the carrier 300 in the optical axis direction (Z-axis direction).

The first yoke 470, according to the present example embodiment, may not be directly inserted into the lower surface of the carrier 300 but may be accommodated in the protrusion 310 disposed on the carrier 300, such that the first yoke 470 may be disposed further downward in the direction of FIG. 4. Accordingly, a distance d1 from the first magnet 410a may be maintained.

Referring to FIGS. 5 and 6, in the optical axis direction (Z-axis direction), the distance d1 between the first magnet 410 and the first yoke 470 may be equal to or greater than a distance d2 between the first magnet 410 and the lower surface of the carrier 300 (d1≥d2).

In addition, in an example embodiment, a distance d3 between the bottom surface of the housing 110 and the first yoke 470 may be less than a distance (d4) between the bottom surface of the housing 110 and the bottom surface of the carrier 300 (d3<d4).

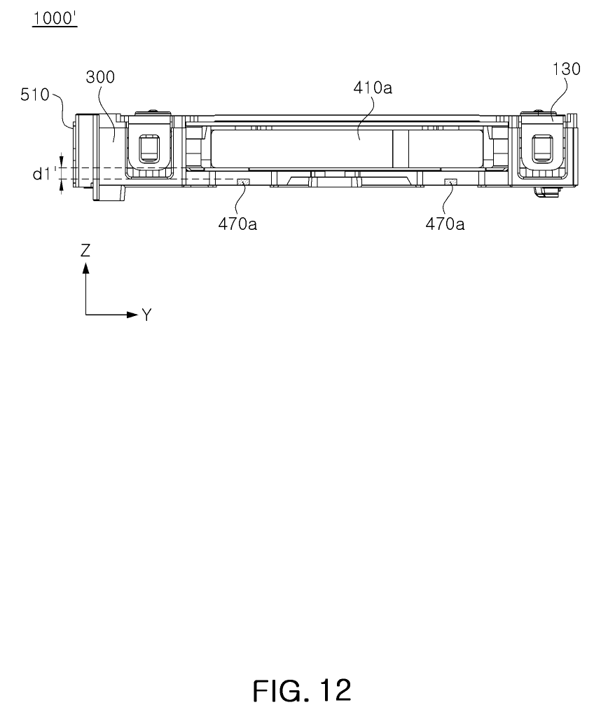

FIG. 12 is a side view of a camera module 1000’ according to a comparative example, corresponding to FIG. 4. The camera module 1000’ of FIG. 12 may have a structure in which a carrier 300 does not include a protrusion and a first yoke 470 is directly inserted into a lower surface of the carrier 300.

When FIGS. 4 and 12 are compared with each other, in the camera module 1000’ of FIG. 12, the first yoke 470 may be directly inserted into a lower surface of a housing 300, such that the first yoke 470 may be disposed to be higher (+Z-direction) than that of the camera module 1000 of FIG. 4.

Accordingly, a distance d1’ between a first magnet 410 and the first yoke 470 may be decreased (d1>d1’), such that a magnetic attractive force acting between the first magnet 410 and the first yoke 470 may be increased, which may affect OIS driving control.

As a result, in the same manner as the camera module 1000 according to an example embodiment of the present disclosure, the distance d1 between the first magnet 410 and the first yoke 470 may be maintained through the protrusion 310, thereby improving the accuracy of OIS driving control.

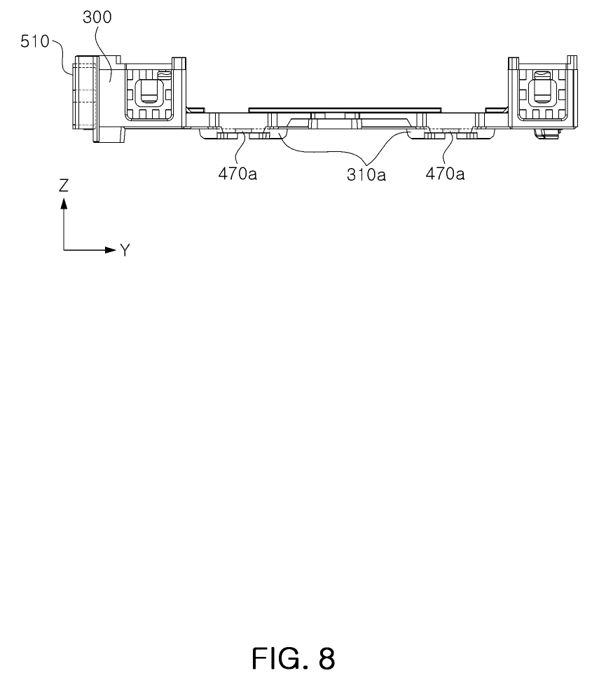

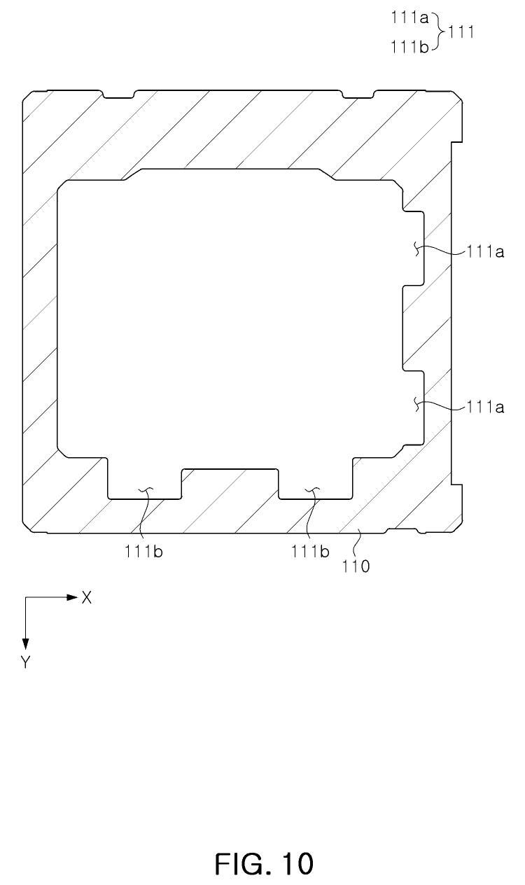

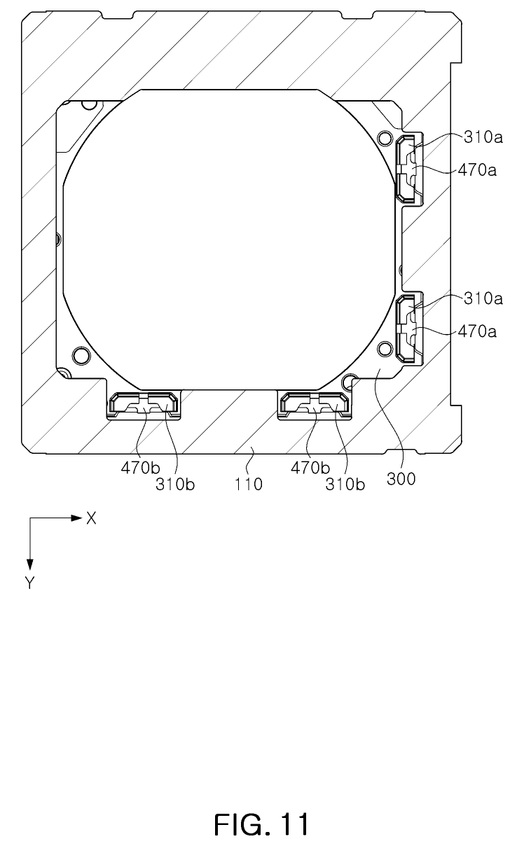

FIG. 8 is a side view of a carrier 300 as viewed in direction “A” of FIG. 1. FIG. 9 is a bottom view of a carrier 300 as viewed in direction “B” of FIG. 1. FIG. 10 is a bottom view of a housing 110 as viewed in direction “B” of FIG. 1. FIG. 11 is a bottom view of a carrier 300 and a housing 110 as viewed in direction B of FIG. 1.

Referring to FIGS. 8 to 11, a carrier 300 according to the present example embodiment may include a protrusion 310 accommodating a first yoke 470. In addition, the housing 110 according to the present example embodiment may have an accommodation groove 111 for avoiding interference with the protrusion 310.

In an example embodiment, a region of the bottom surface of the housing 110, opposing the protrusion 310, may have an accommodation groove 111.

The accommodation groove 111 may be disposed in a region of the bottom surface of the housing 110, overlapping the protrusion 310 in an optical axis direction (Z-axis direction).

In an example embodiment, the protrusion 310 may be exposed through the accommodation groove 111 in the optical axis direction (Z-axis direction). The protrusion 310 may be exposed toward an image sensor module 700 through the accommodation groove 111.

At least a portion of the protrusion 310 may be accommodated in the accommodation groove 111.

When the carrier 300 is driven in the optical axis direction (Z-axis direction) due to an AF operation, at least a portion of the protrusion 310 may be accommodated in the accommodation groove 111 in the optical axis direction (Z-axis direction).

The camera module 1000, according to an example embodiment of the present disclosure, may prevent the protrusion 310 of the carrier 300 and the housing 110 from coming into contact with each other or colliding with each other due to movement of the carrier 300 in the optical axis direction (Z-axis direction) during AF driving or the occurrence of external impacts.

In addition, the accommodation groove 111 may have a length in an X-axis direction and/or a Y-axis direction greater than that of the protrusion 310. Through such a structure, the protrusion 310 and the accommodation groove 111 may have a distance therebetween, thereby preventing collision or contact between the protrusion 310 and the housing 110 during the occurrence of external impacts or OIS driving.

Referring to FIGS. 9 to 11, the camera module 1000 according to the present example embodiment may include a plurality of protrusions 310 and a plurality of accommodation grooves 111.

In an example embodiment, the protrusion 310 may include a first protrusion 310a disposed to be parallel to the Y-axis direction, and a second protrusion 310b disposed to be parallel to the X-axis direction. A first-first yoke 470a may be accommodated in the first protrusion 310a, and a first-second yoke 470b may be accommodated in the second protrusion 310b.

The first protrusion 310a may be provided as a plurality of first protrusions 310a. For example, two first protrusions 310a may be disposed to oppose two polarities of the first-first magnet 410a.

In addition, the second protrusion 310b may be provided as a plurality of second protrusions 310b. For example, two second protrusions 310b may be disposed to oppose two polarities of the first-second magnet 410b.

In an example embodiment, the accommodation groove 111 may include a first accommodation groove 111a disposed to be parallel to the Y-axis direction, and a second accommodation groove 111b disposed to be parallel to the X-axis direction.

The first accommodation groove 111a may be provided as a plurality of first accommodation grooves 111a. For example, the plurality of first accommodation grooves 111a may be disposed to correspond to the plurality of first protrusions 310a, respectively.

In addition, the second accommodation groove 111b may be provided as a plurality of second accommodation grooves 111b. For example, the plurality of second accommodation grooves 111b may be disposed to correspond to the plurality of second protrusions 310b, respectively.

Referring to FIG. 9, the first-first yoke 470a and the first-second yoke 470b may be provided as a plurality of first-first yokes 470a and a plurality of first-second yokes 470b, respectively. For example, two first-first yokes 470a may be disposed to oppose regions (for example, an N-pole region and an S-pole region) having different polarities of the first-first magnet 410a in the optical axis direction (Z-axis direction), respectively. In addition, two first-second yokes 470b may be disposed to oppose regions (for example, an N-pole region and an S-pole region) having different polarities of the first-second magnet 410b in the optical axis direction (for example, an N-pole region and an S-pole region), respectively.

The first yoke 470 may generate an attractive force in a direction opposing the first magnet 410, that is, the optical axis direction (Z-axis direction), and the holder 330 may be in close contact with the carrier 300 by the attractive force.

Hereinafter, a component for AF driving of the camera module 1000 according to an example embodiment of the present disclosure will be described.

Referring to FIGS. 2, 3, and 5, the camera module 1000 according to an example embodiment of the present disclosure may include a second driving portion 500 generating a driving force in an optical axis direction (Z-axis direction).

The second driving portion 500 may include a second magnet 510 and a second coil 530. The second magnet 510 may be disposed on one side surface of the carrier 300, and the second coil 530 may be disposed on one side surface of the housing 110 opposing the one side surface of the carrier 300 on which the second magnet 510 is disposed.

The second magnet 510 may include regions having different polarities in the optical axis direction (Z-axis direction). For example, the second magnet 510 may include an N-pole region and an S-pole region in the optical axis direction (Z-axis direction), and may include a neutral region between the N-pole region and the S-pole region, but the present disclosure is not limited thereto. The second magnet 510 may be implemented as a combination of unipolar magnets having an N-pole or an S-pole without a neutral region.

In an example embodiment, the second coil 530 may be disposed on a main substrate 610 disposed on a side surface of the housing 110. A through-hole may be formed in the side surface of the housing 110, and the second coil 530 may directly oppose the second magnet 510 through the through-hole.

The second magnet 510 and the second coil 530 may be disposed to oppose each other in a direction perpendicular to an optical axis, to generate a driving force in the optical axis direction (Z-axis direction).

A second position sensor 550 may be disposed on the main substrate 610 together with the second coil 530, and a position of the lens module 200 in the optical axis direction may be detected through the second position sensor 550.

In an example embodiment, the second position sensor 550 may be a Hall sensor, but the present disclosure is not limited thereto. The second position sensor 550 may be implemented as other types of sensors, such as a gyroscope or an accelerometer.

Referring to FIG. 3, a second ball member B2 may be disposed between the carrier 300 and the housing 110 to guide movement of the carrier 300 in the optical axis direction (Z-axis direction).

The second ball member B2 may include a plurality of ball members. The second ball member B2 may be divided into two groups, including one or more ball members, and disposed on both sides of the second magnet 510 in a length direction (X-axis direction).

Guide grooves G2 and G3 in which the second ball member B2 is accommodated may be disposed in the carrier 300 and the housing 110. Specifically, a side surface of the carrier 300 may have a second guide groove G2, and a surface of the housing 110, opposing the second guide groove G2, may have a third guide groove G3.

The guide grooves G2 and G3 may extend in the optical axis direction (Z-axis direction), and the second ball member B2 may roll within the guide grooves G2 and G3 in the optical axis direction in a state of being accommodated in the guide grooves G2 and G3.

The carrier 300 may be supported by the housing 110 with the second ball member B2 interposed therebetween. In an example embodiment, a second yoke 570 may be disposed in the housing 110 to oppose the second magnet 510 with the second ball member B2 interposed therebetween. The second yoke 570 and the second magnet 510 may generate an attractive force in a direction in which the second yoke 570 and the second magnet 510 oppose each other, that is, a direction perpendicular to the optical axis (Y-axis direction), and the carrier 300 may be in close contact with the housing 110 by the attractive force.

The second yoke 570 may correspond to a magnetic body, and may be configured to concentrate the magnetic force generated in the second magnet 510 by forming a magnetic circuit with the second magnet 510.

During focus adjustment of the camera module 1000, the holder 330 and the lens module 200 may also move in the optical axis direction together with the carrier 300.

In an example embodiment, the holder 330 may be accommodated in the carrier 300, and a first ball member B1 may be disposed between the carrier 300 and the holder 330. The holder 330 may be supported by the carrier 300 through the first ball member B1. Accordingly, when the carrier 300 moves in the optical axis direction (Z-axis direction), the holder 330 and the carrier 300 may also move in the optical axis direction (Z-axis direction). Similarly, the lens module 200 coupled to the holder 330 may also move in the optical axis direction to implement AF.

As described above, in the camera module 1000 according to an example embodiment of the present disclosure, the holder 330 may be directly disposed on the carrier 300 without a component (for example, a ball guide frame) disposed between the carrier 300 and the holder 330, which may be advantageous for reducing thickness. In addition, when the above structure is used, a distance between the first magnet 410 and the first yoke 470 may be decreased, and it may be difficult to perform driving control due to a strong magnetic attractive force caused by the decreased distance. The camera module 1000, according to the present example embodiment, may include the protrusion 310 for accommodating the first yoke 470, thereby resolving such an issue.

An aspect of the present disclosure is to provide a camera module having a structure in which a lens holder is directly disposed on a carrier while a sufficient distance between an OIS driving magnet and a yoke is maintained.

Another aspect of the present disclosure is to provide a camera module in which a sufficient distance is maintained between an optical image stabilization (OIS) driving magnet and a yoke, thereby improving the accuracy of OIS driving.

According to example embodiments of the present disclosure, a camera module may have a reduced thickness due to a structure in which a lens holder is directly disposed on a carrier, while a sufficient distance between an OIS driving magnet and a yoke may still be maintained.

According to example embodiments of the present disclosure, in a camera module, a sufficient distance between an OIS driving magnet and a yoke may be maintained, thereby improving the accuracy of OIS driving.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing;
a carrier, disposed in the housing, movable in an optical axis direction with respect to the housing, and comprising a protrusion;
a holder, disposed on the carrier, movable in a direction perpendicular to an optical axis with respect to the carrier, and configured to support a lens module;
a first magnet disposed on one side surface of the holder; and
a first yoke disposed in the protrusion to oppose the first magnet in the optical axis direction,
wherein the protrusion protrudes from a lower surface of the carrier toward a bottom surface of the housing.

2. The camera module of claim 1, wherein, in the optical axis direction, a distance between the first magnet and the first yoke is greater than or equal to a distance between the first magnet and a lower surface of the carrier.

3. The camera module of claim 1, wherein a region of the bottom surface of the housing, opposing the protrusion, has an accommodation groove.

4. The camera module of claim 3, wherein the protrusion is exposed in the optical axis direction through the accommodation groove.

5. The camera module of claim 3, wherein at least a portion of the protrusion is accommodated in the accommodation groove.

6. The camera module of claim 1, further comprising:
a first driving portion configured to provide a driving force to the holder,
wherein the first driving portion comprises the first magnet and a first coil disposed to oppose the first magnet in the direction perpendicular to the optical axis.

7. The camera module of claim 1, wherein the holder is supported by the carrier in the optical axis direction.

8. The camera module of claim 1, further comprising:
a first ball member disposed between the carrier and the holder.

9. The camera module of claim 8, wherein the first ball member is in contact with each of the carrier and the holder at one point in the optical axis direction.

10. The camera module of claim 1, further comprising:
a second driving portion configured to provide a driving force to the carrier,
wherein the second driving portion comprises a second magnet disposed on a side surface of the carrier, and a second coil disposed to oppose the second magnet in the direction perpendicular to the optical axis.

11. The camera module of claim 1, wherein the carrier is supported by the housing in the direction perpendicular to the optical axis.

12. The camera module of claim 1, further comprising:
a second ball member disposed between the housing and the carrier.

13. A camera module comprising:
a housing;
a carrier, disposed in the housing, movable in an optical axis direction with respect to the housing;
a holder, disposed on the carrier, movable in at least two axial directions, perpendicular to an optical axis, with respect to the carrier;
a first-first magnet disposed on one side surface of the holder; and
a first-first yoke, disposed on a lower surface of the carrier, configured to apply magnetic attractive force to the first-first magnet in the optical axis direction,
wherein a distance between a bottom surface of the housing and the first-first yoke is less than a distance between the bottom surface of the housing and the lower surface of the carrier.

14. The camera module of claim 13, further comprising:
a first-second magnet disposed on another side surface of the holder extending from the one side surface; and
a first-second yoke, disposed on the lower surface of the carrier, configured to apply magnetic attractive force to the first-second magnet in the optical axis direction.

15. The camera module of claim 13, wherein the first-first magnet comprises regions having different polarities in a direction perpendicular to the optical axis.

16. The camera module of claim 15, wherein the first-first yoke comprises a plurality of first yokes, and
wherein each of the plurality of first yokes is disposed to oppose, in the optical axis direction, a respective polarity region within the first-first magnet.
